(19) United States
(12) Patent Application Publication
(10) Pub. No.: US 2004/0252776 A1
(43) Pub. Date: Dec. 16, 2004

(54) Low data rate/low power multi-band-OFDM

(76) Inventors: Jaiganesh Balakrishnan, Dallas, TX (US); Anuj Batra, Dallas, TX (US)

Correspondence Address: TEXAS INSTRUMENTS INCORPORATED, P O BOX 655474, M/S 3999, DALLAS, TX, 75265

(21) Appl. No.: 10/858,273

(22) Filed: Jun. 1, 2004

Related U.S. Application Data
(60) Provisional application No. 60/477,992, filed on Jun. 11, 2003.

(51) Int. Cl. H04L 27/28

(52) U.S. Cl. 375/260

(57) ABSTRACT

Method for providing a low data rate and low power digital communications system. A preferred embodiment comprises reducing power consumption by reducing the precision (and hence complexity) of circuitry in devices in the digital communications system. This can be achieved by giving up some excess link margin. Furthermore, mixers and frequency synthesizers that support interference avoidance techniques such as time-frequency interleaving can be turned off while a transmission is taking place. Data rate can also be reduced by reducing the number of symbols actually carrying data. No signal or zero signal can replace actual data symbols when a lower data rate is desired.

This application claims the benefit of U.S. Provisional Application No. 60/477,992, filed Jun. 11, 2003, entitled “Low Data Rate/Low Power TFI-OFDM Devices”, which application is hereby incorporated herein by reference.

### CROSS-REFERENCE TO RELATED APPLICATIONS

This application is related to the following co-pending and commonly assigned patent applications: Ser. No. 10/688,169, filed Oct. 18, 2003, entitled “Time-Frequency Interleaved Orthogonal Frequency Division Multiplexing Ultra Wide Band Physical Layer,” which application is incorporated by reference; patent application entitled “Multi-Band OFDM Communications System”, Attorney Docket Number TI-36381; Ser. No. 10/782,095, filed Feb. 19, 2003, entitled “Preamble for a TFI-OFDM Communications System,” Attorney Docket Number TI-36097.

### TECHNICAL FIELD

The present invention relates generally to a method for digital communications, and more particularly to a method for providing low data rate and low power digital communications system.

### BACKGROUND

The current push in digital wireless communications systems is to increase the data rate so that the data rates can approach the data rates offered by wired communications systems. One reason to increase the data rate of a communications system is to increase the number and types of applications that can be supported in these communications systems. For example, a higher data rate can mean that it can support more users and/or multimedia (including video) can now be carried in a communications system that was heretofore limited to carrying music or data. However, even in communications systems that can support communications at data rates of 110 Mbps or more, there can be times when there is relatively little data being transmitted. Furthermore, there may be times when it is desirable to minimize power consumption, to extend the battery life of battery powered devices in these communications networks, for example. Therefore, there can exist a desire to provide a low data rate and/or low power option for these communications systems.

Furthermore, it may be desirable to have a single design for a wireless communications system that can be used to provide high data rates for applications that demand the large bandwidth and using the same design, provide a low data rate, low performance communications system for applications such as peripheral interconnection, input/output devices, remote controls, and so on. The use of a single design can reduce research and development costs as well as manufacturing costs, which can be passed onto the end-user or increase profit margins for the equipment manufacturer.

A commonly used technique that is often used to help reduce power consumption involves placing inactive devices into a sleep or suspend mode. These devices could then periodically wake up to determine if there are transmissions that are destined for them. If the ratio of time spent in sleep (or suspend) mode to active mode is relatively high, then a considerable reduction in power consumption can be achieved. For instance, if the active mode power consumption is approximately ten times the sleep mode power consumption and the ratio of sleep mode to active mode is two (two time periods in sleep mode for each time period in active mode), then the average power consumption may be approximately 40 percent of the power consumed if the device was in the active mode at all times.

Another technique to reduce data rates is to repeat the information being transmitted multiple times until the desired data rate is achieved. For example, if a communications system is capable of a data rate of 110 Mbps, by simply duplicating the information being transmitted, the data rate can drop to 55 Mbps. Further data rate reductions can be achieved by replicating the information to a greater extent.

One disadvantage of the prior art is that while placing devices into a sleep mode can reduce power consumption, the data rate of the communications network is not being reduced. While the devices are brought back into an active mode, transmissions may still be taking place at the full transfer rate. Therefore, when in an active mode, the devices are consuming power at their usual rate and no reduction in power consumption is seen.

A second disadvantage of the prior art is that by replicating the information being transmitted, the data rate is being reduced, but the power consumption may remain the same. Analog receiver and transmitter circuitry may not care if it is transmitting a duplicate of information it has already transmitted and will consume the same amount of power in transmitting the original piece of information as it does transmitting the duplicates.

### SUMMARY OF THE INVENTION

These and other problems are generally solved or circumvented, and technical advantages are generally achieved, by preferred embodiments of the present invention which provides for a method for reducing data rate and power consumption in a wireless communications system.

In accordance with a preferred embodiment of the present invention, a method for reducing power consumption and data transfer rate in a wireless communications system comprising determining a desired data transfer rate to full data transfer rate ratio (DFR) and transmitting actual data symbols at an actual data symbols to full data symbols ratio (AFR) that is substantially equal to the DFR.

In accordance with another preferred embodiment of the present invention, a method for adjusting the precision of circuitry in a wireless communications system comprising measuring a performance metric of a receiver. The method further includes increasing the precision of circuitry if the performance metric exceeds a first specified threshold. Additionally, the method includes obtaining a power consumption estimate of the receiver and decreasing the precision of the circuitry if the power consumption estimate exceeds a second specified threshold. Finally, repeating the adjusting of the precision of the circuitry according to a performance requirement.

In accordance with yet another preferred embodiment of the present invention, a method for reducing power consumption in a wireless communications system comprising determining if a transmission is taking place and changing transmission band at a next interval if a transmission is not taking place. The method further comprises maintaining the transmission band if a transmission is taking place.

An advantage of a preferred embodiment of the present invention is that a communications system's data rate and power consumption can be reduced by taking advantage of the communications system's link margin. This can be achieved without needing any changes to the design of the communications system.

A further advantage of a preferred embodiment of the present invention is that a single communications system design can be used to provide a high performance system, a medium performance system, or a low performance system, depending upon end user requirements. This can result in savings for equipment manufacturers since only a single design needs to be developed and tested.

Yet another advantage of a preferred embodiment of the present invention is that the power reduction techniques of the present invention can be combined with other power reduction techniques, such as a sleep mode, to further reduce power consumption.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a frequency allocation map for a Multi-band-OFDM communications system;

FIG. 2 is a time-space diagram of a Multi-band-OFDM communications system with three transmission bands;

FIG. 3 is a diagram of a transmitter in a Multi-band-OFDM communications system;

FIG. 4 is a diagram of a receiver in a Multi-band-OFDM communications system;

FIG. 5 is a flow diagram of an algorithm for reducing data rate and power consumption by reducing a pulse repetition frequency, according to a preferred embodiment of the present invention;

FIG. 6 is a flow diagram of an algorithm for reducing power consumption by reducing circuit complexity, according to a preferred embodiment of the present invention;

FIG. 7 is a data plot of packet error rate as a function of E_{b}/Nₒ for different analog-to-digital converter precision, according to a preferred embodiment of the present invention; and

FIG. 8 is a flow diagram of an algorithm for reducing power consumption by reducing the use of time-frequency interleaving, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a multi-band, orthogonal frequency division multiplexed (Multi-band-OFDM) communications system, for example, such as one that is adherent to IEEE 802.15.3a technical specifications. The IEEE 802.15.3a technical requirements can be found in a document entitled “TG3a Technical Requirements,” published Dec. 27, 2002, which is herein incorporated by reference. The invention may also be applied, however, to other wireless communications systems that wish to reduce power consumption and data rates by taking advantage of available link margin.

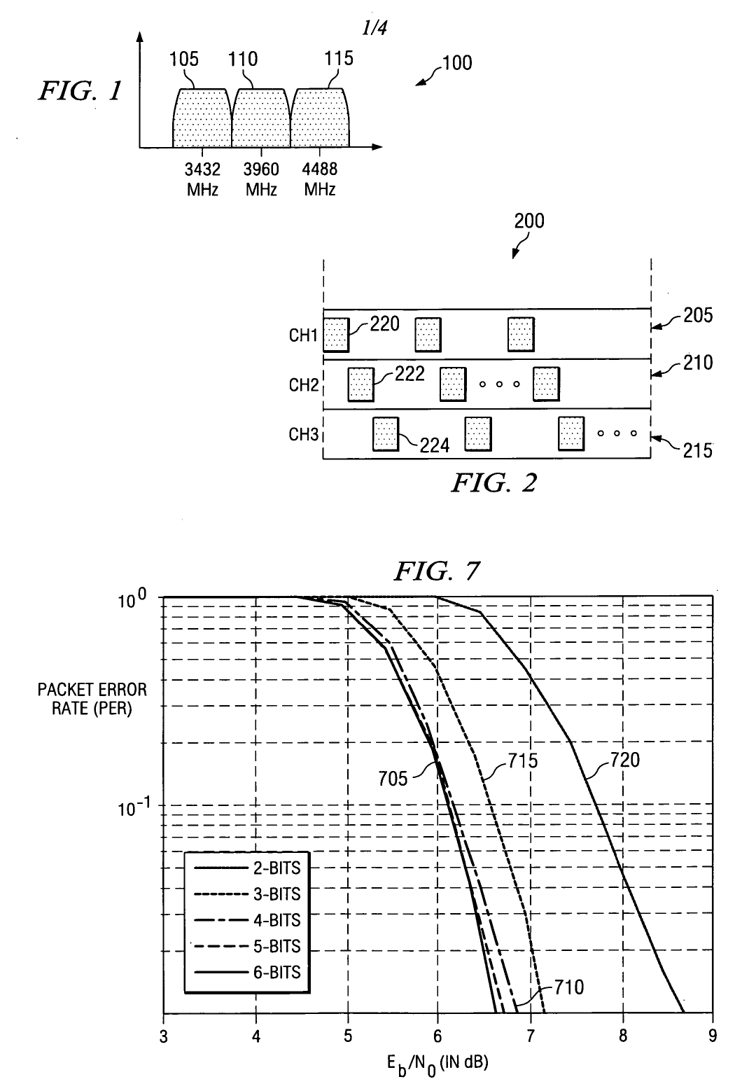

With reference now to FIG. 1, there is shown a diagram illustrating a frequency allocation map 100 for an exemplary first-generation Multi-band-OFDM communications system. FIG. 1 displays the frequency allocation map 100 for an exemplary Multi-band-OFDM communications system that meets the technical requirements of IEEE 802.15.3a, namely a data rate of at least 110 Mbps at a distance of 10 meters. The exemplary Multi-band-OFDM communications system also meets the other technical requirements of IEEE 802.15.3a, which can include the ability to accept interference from other electronic devices and to not cause undue interference to other electronic devices operating within certain specified frequency bands.

Note that the frequency allocation map 100 shows a communications system with three transmission bands: a first transmission band 105 (transmission band #1) with a center frequency at 3.432 GHz, a second transmission band 110 (transmission band #2) with a center frequency at 3.960 GHz, and a third transmission band 115 (transmission band #3) with a center frequency at 4.488 GHz. It may be possible to create different frequency allocation maps for other Multi-band-OFDM communications systems that will continue to meet IEEE 802.15.3a technical requirements, such as one with six or seven transmission bands of varying size and center frequencies.

With reference now to FIG. 2, there is shown a diagram illustrating a time-space diagram 200 for an exemplary Multi-band-OFDM communications system with three transmission bands. In order to make good use of the three transmission bands, the Multi-band-OFDM communications system should make use of time-frequency interleaving, wherein a transmitter in the communications system will transmit in one frequency band for period of time and then switch to another frequency band to transmit for another period of time. Time-frequency interleaving is a technique commonly used to permit sharing of available bandwidth between multiple transmitters (or networks) and to help reduce the probability of collisions, from other transmissions and interference. Time-frequency interleaving is considered to be a well known technique by those of ordinary skill in the art of the present invention.

The time-space diagram 200 illustrates a fairly simple time-frequency interleaving pattern for a transmitter in the exemplary communications system, wherein the transmitter can initially transmit in transmission band #1, also referred to as channel 1 or CH1, and then switch to transmission band #2 followed by transmission band #3. This particular interleaving pattern can be referred to as the [1 2 3], wherein the numbers indicate the transmission bands. After the third transmission band, the pattern can repeat. Note that other interleaving patterns can be possible, with varying length, such as [1 3 2], [1 1 2 2 3 3], [1 1 3 3 2 2], and so on.

A first band 205 illustrates transmissions on channel 1 (CH1), while a second band 210 and a third band 215 illustrate transmissions on channels 2 (CH2) and 3 (CH3) respectively. The first, second, and third bands 205, 210, and 215 illustrate transmissions on the respective channels via shaded blocks such as blocks 220, 222, and 224. Using an interleaving pattern, such as the interleaving pattern [1 2 3] discussed above, a transmitter may initially transmit on channel 1 (block 220), followed with a transmission on channel 2 (block 222), and finally a transmission on channel 3 (block 224). If the transmitter has additional transmissions, then the transmitter would return to channel 1 and repeat the interleaving pattern. Note that if the transmitter does not have a transmission during a transmission period, the transmitter may then skip the transmission period and associated channel for that transmission period.

According to the IEEE 802.15.3a technical requirements, a wireless communications system should have at least 110 Mbps with a separation of 10 meters between transmitter and receiver. A communications system using Multi-band-OFDM can achieve this data rate requirement at ranges of greater than 10 meters in various multipath environments. When lower data rates are desired, the Multi-band-OFDM communications system can have an excess link margin at 10 meters. Link margin is considered to be a widely known concept to those of ordinary skill in the art of the present invention. For example, if the data rate is dropped to 11 Mbps (a factor of 10 drop in data rate), the Multi-band-OFDM communications system can have an excess link margin of approximately 10 dB at 10 meters. This excess link margin can be exploited to lower the power consumption of the Multi-band-OFDM communications system when low data rate transmissions are used.

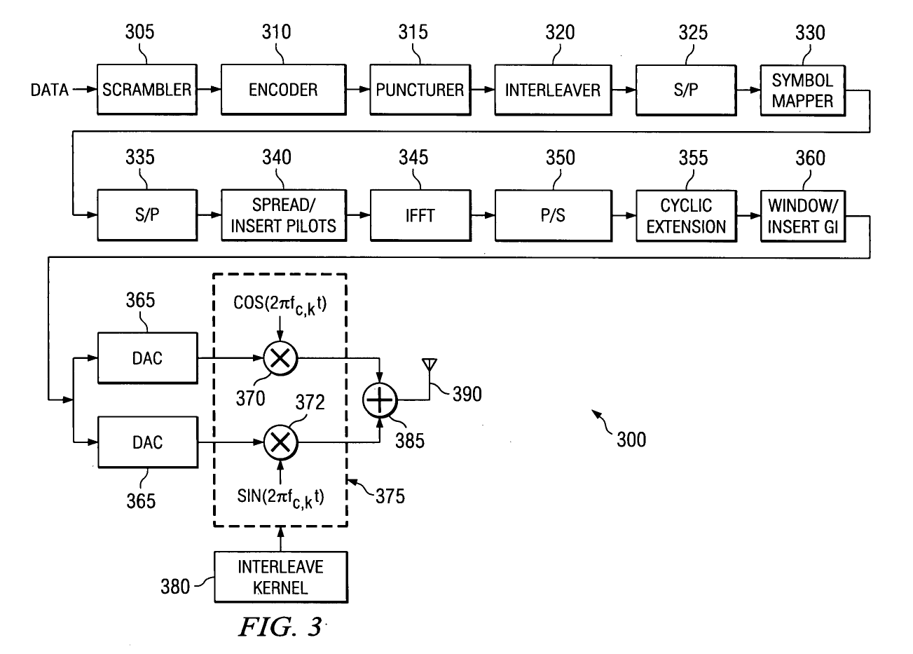

With reference now to FIG. 3, there is shown a diagram illustrating a transmitter 300 for a Multi-band-OFDM communications system. FIG. 3 displays a functional level block diagram of the transmitter 300 for a Multi-band-OFDM communications system. Note that the functional blocks that make up the transmitter 300 are considered to be well understood by those of ordinary skill in the art of the present invention and will not be described in detail. Data, which can be provided at up to 110 Mbps can be provided to a scrambler 305 wherein a scrambling code can be applied to the data. After scrambling, an encoder 310 can be used to apply a code to the scrambled data, producing a symbol stream. The code may be an error detecting and correcting code, which can be used to help detect and correct small errors that may occur during transmission. A puncturer 315 can be used to remove certain specified symbols from the symbol stream. In place of the symbols that were removed (punctured), certain codes can be inserted that can help the performance of the communications system.

Another technique to help improve error tolerance of the transmission is to interleave the symbol stream. An interleaver 320 can be used to interleave the symbol stream to help reduce the likelihood that adjacent symbols will be damaged by changing the transmit order of the symbol stream. A serial-to-parallel (S/P) unit 325 can convert the symbol stream, which may have been heretofore a serial stream of symbols into a parallel stream. A symbol mapper 330 can be used to map data symbols into an OFDM symbol. An OFDM symbol may represent multiple data symbols, depending upon the number of tones in the OFDM symbol and the quality of the communications channel at the frequency range represented by the OFDM symbol. A second S/P unit 335 can convert the serial OFDM symbols (as produced by the symbol mapper 330) into a parallel stream of OFDM symbols.

A spread/insert pilots unit 340 can be used to apply a spreading code (as well as pilots) to the OFDM symbols. An inverse Fourier transform unit 345 can convert the frequency domain OFDM symbols into time domain symbols. Preferably, an implementation of the inverse Fast Fourier Transform can be used in the inverse Fourier Transform unit 345. A parallel-to-serial (P/S) unit 350 serializes the time domain symbols in preparation for transmission. A cyclic extension unit 355 can be used to put a copy of a portion of a time domain symbol at the time domain symbol's beginning. Alternatively, in place of the cyclic extension, a zero-padded prefix can be added to the beginning of the time domain symbol. In either case, the cyclic extension or the zero-padded prefix can be used to help combat inter-symbol interference. A windowing/guard interval unit 360 can be used to place a guard interval (also referred to as a guard band) between symbols. Finally, a pair of digital-to-analog converters (DAC) 365 convert the time domain symbols into their analog representations prior to providing the symbols to analog circuitry. Note the pair of DACs 365 provide an in-phase and a quadrature phase stream.

Analog circuitry, such as mixers 370 and 372, which are part of a time-frequency interleaving unit 375, can be used to bring the analog representations of the time domain symbols, which were at an internal frequency, to the carrier frequency. Note that the mixers 370 and 372 can also be used to generate in-phase and quadrature phase versions of the analog stream. Since the Multi-band-OFDM communications system uses time-frequency interleaving, the time-frequency interleaving unit 375 can be used to place the individual transmission units at different transmission bands. The granularity of the time-frequency interleaving may determine how often the time-frequency interleaving unit 375 changes the frequency of the analog stream. For example, if the transmission band is to change for every symbol being transmitted, then the time-frequency interleaving unit 375 may change frequencies more rapidly than if the transmission band changes after every packet transmitted. The time-frequency interleaving unit 375 may receive the sequence of transmission bands from an interleave kernel 380, which may contain the interleaving sequence and other information, such as the frequency of frequency changes and so forth. Output from the time-frequency interleaving unit 375 can be combined by an adder 385 and then transmitted via an antenna 390. Note that additional analog signal processing, such as amplifying and filtering, may be required for the analog signal prior to transmission. This additional analog signal processing may not be shown in FIG. 3.

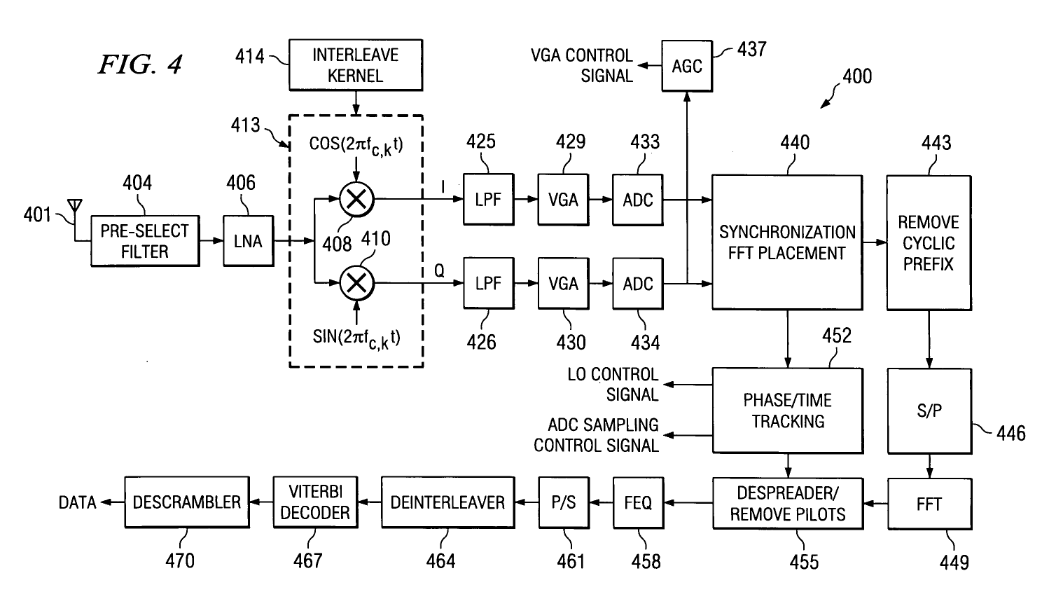

With reference now to FIG. 4, there is shown a diagram illustrating a receiver 400 for a Multi-band-OFDM communications system. Similar to FIG. 3, FIG. 4 displays a functional level block diagram of the receiver 400 for a Multi-band-OFDM communications system. An antenna 401 can be used to receive the transmissions that were broadcast over-the-air by a transmitter, such as the transmitter 300. The received transmission, which may contain more than what was transmitted by the transmitter 300, can be provided to a pre-select filter 404 to help eliminate out-of-band signals, noise, and interference. The pre-select filter 404 can also be used to selectively pass portions of a frequency band of the communications system. For example, the communications system may be configured to use only a few transmission bands out of a greater number of transmission bands that can be used. Therefore, the pre-select filter 404 can be configured to pass only signals from these few transmission bands and to reject signals that are not in these few transmission bands.

A low-noise amplifier (LNA) 406 can be used to amplify the output of the pre-select filter 404 to bring the output to a signal level that may be compatible to circuitry in the remainder of the receiver 400. A pair of mixers 408 and 410 (making up a time-frequency interleaving unit 413) can be used to down-convert the received signal into an internal frequency for processing. Note that since the transmitted signal contained two streams (in-phase and quadrature phase streams), the mixers 408 and 410 may apply similar mixing to perform the down-conversion.

The time-frequency interleaving unit 413, in conjunction with an interleave kernel 414, can be used to take the received signal (both streams) that may have been transmitted in different transmission bands (i.e., with time-frequency interleaving) and to combine them into two streams with the time-frequency interleaving removed. This can be accomplished by multiplying the transmissions in the different transmission bands with carrier frequencies that are specified by the interleave kernel 414. Note that the interleave kernel 414 may need to be in synchrony with the interleave kernel 380 (FIG. 3) to enable combining of the transmissions in the different transmission bands. This may require that the receiver 400 and the transmitter 300 use the same interleaving pattern and be relatively synchronized in time.

Each of the two streams can be provided to a low-pass filter 425 (and 426) to help eliminate undesired signals and noise at frequencies greater than the bandwidth of a transmission band. Each stream may also be provided to a variable gain amplifier (VGA) 429 (and 430) that may be controlled via feedback to adjust the magnitude of the signals in the stream. The VGA 429 (and 430) can be used to optimize the performance of an analog-to-digital converter (ADC) 433 (and 434). The signal magnitude can be adjusted to maximize the usage of the resolution of the ADC 433 (and 434) without clipping. An output from the ADC, preferably ADC 434 but the output of ADC 433 may also be used, can be provided to an automatic gain control (AGC) unit 437 that can provide a feedback control signal to adjust the gain of the VGA 429 (and 430). For example, if the AGC 437 determines that the output of the ADC 434 is small, then it can increase the gain of the VGA 429 (and 430) so that the output of the ADC 434 (and 433) increases.

Output from the ADCs 433 and 434 (the digitized streams) can be provided to a synchronization/FFT placement unit 440 that can be used to make sure that the two digitized streams have consistent timing (i.e., the two digitized streams are synchronized). The two streams can also be combined back into a single stream. Then, any cyclic prefix or zero-padded prefix can be removed by a remove cyclic prefix unit 443. Note that for systems using zero-padded symbols, an overlap-and-add unit (not shown) may be needed to ensure the proper recombination of the stream. A serial-to-parallel (S/P) unit 446 can be used to convert the single stream into a stream of symbols. The symbol stream can then be provided to a Fourier transform unit 449 for conversion back into frequency domain symbols. The Fourier transform unit 449 preferably implements a form of the Fast Fourier transform, however, other Fourier transform algorithms may be used. The synchronization/FFT placement unit 440 can also provide the single stream to a phase/time tracking unit 452, which can be used to derive control signals for controlling the operation of the receiver's local oscillator (LO) and for adjusting the sampling of the ADCs 433 and 434 to help maximize the signal quality.

The frequency domain symbols (produced by the Fourier transform unit 449) may be provided to a despreader 455, which may also receive phase/time tracking information from the phase/time tracking unit 452. The despreader 455 can be used to remove a spreading code that may have been applied to the frequency domain symbols prior to transmission. The despreader 455 can also remove pilots that may have also been inserted into the frequency domain symbols. Output of the despreader 455 can be provided to a frequency domain equalizer (FEQ) 458. The FEQ 458 can be used to shorten the communications channel. Another parallel-to-serial unit 461 can be used to convert an output of the FEQ 458 back into a form that can be similar to the way the frequency domain symbols were arranged prior to their transmission.

Any interleaving that was applied can be removed by a deinterleaver 464 while a decoder 467 can be used to extract the transmitted data from the error detecting and correcting code. The decoder 467 can perform some error detecting and correcting. Preferably, the decoder 467 implements a Viterbi decoder, which is a commonly used type of decoder algorithms. Finally, a descrambler 470 can be used to remove a scrambling code that may have been applied to the data by a transmitter. After the descrambling, a stream of data at the transmitted data rate can be provided at the output of the descrambler 470 for use by devices coupled to the receiver 400.

The IEEE 802.15.3a technical requirements specify a data rate of 110 Mbps at 10 meters. In order to drop down to 11 Mbps at 10 meters, a combination of coding and frequency domain spreading can be used. As discussed previously, a Multi-band-OFDM wireless communications system, designed to be compliant to the IEEE 802.15.3a technical requirements, can have excessive link margin when the data rate is reduced to 11 Mbps at 10 meters. This link margin can be exploited to enable a further reduction in data rate along with a reduction in power consumption.

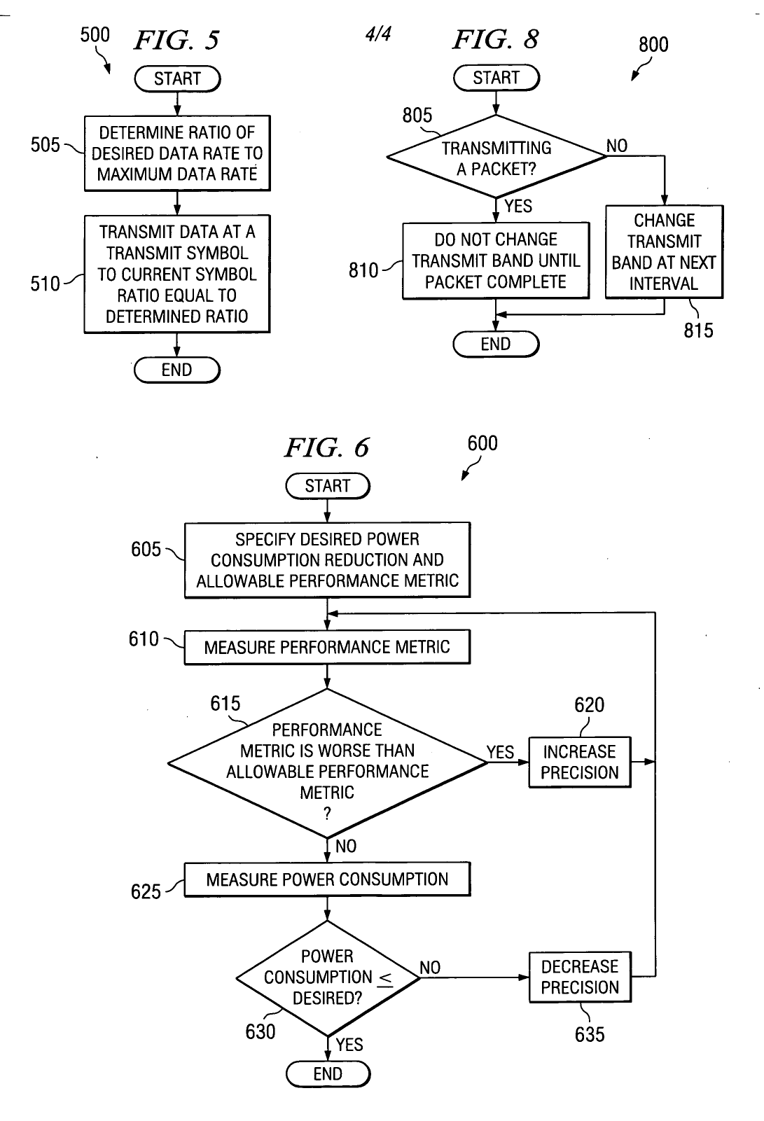

With reference now to FIG. 5, there is shown a flow diagram illustrating an algorithm 500 for reducing data rate and power consumption via a reduction in a pulse repetition frequency, according to a preferred embodiment of the present invention. The pulse repetition frequency (PRF) specifies the frequency in which actual symbols are transmitted by a transmitter. For example, if the Multi-band-OFDM communications system can achieve a data rate of 11 Mbps using full PRF, then a data rate of 5.5 Mbps can be achieved by transmitting one OFDM symbol (a total of 312.5 ns) during a duration that typically carries two OFDM symbols (625 ns). According to a preferred embodiment of the present invention, during the time that would normally be dedicated to transmitting the second OFDM symbol, no symbol will be transmitted. Alternatively, a symbol with zero value will be transmitted during the time that would have normally be used for transmitting the second OFDM symbol.

When a single OFDM symbol is transmitted in place of two OFDM symbols, the power consumption can be reduced, typically by a factor of two. Furthermore, at the transmitter, rather than computing an inverse Fourier transform (at the inverse Fourier transform unit 345 (FIG. 3) twice within 625 ns, it needs to be computed only once. Therefore, power consumption from the computation of the inverse Fourier transform can be decreased by a factor of two. At the receiver, the Fourier transform of only one OFDM symbol needs to be computed (at the Fourier transform unit 449 (FIG. 4) instead of two. Additional power savings can also be realized with reduced post-Fourier transform computations such as frequency equalization (at the FEQ 458 (FIG. 4)), phase and time tracking (at the phase/time tracking unit 452 (FIG. 4)), and so on.

In addition to transmitting a single OFDM symbol instead of two OFDM symbols, it can be possible to change the amount of data rate reduction and power consumption reduction by changing a ratio of actual transmitted OFDM symbols to potential transmitted OFDM symbols. For example, in an interval where there is sufficient time to transmit a total of N OFDM symbols, anywhere from one to N−1 OFDM symbols can be transmitted in order to reduce both data rate and power consumption. Then, if N is equal to four, then if only one OFDM symbol was transmitted, then the data rate and power consumption will be approximately one-quarter of the maximum. If two OFDM symbols were transmitted, then the data rate and power consumption would be approximately one-half of the maximum and if three OFDM symbols where transmitted, then the data rate and power consumption would be approximately three-quarters of the maximum.

According to a preferred embodiment of the present invention, the algorithm 500, which can be used to specify the desired data rate, can execute on a controller, a general purpose processing unit, a dedicated processing unit, or a custom designed integrated circuit that may be responsible for the operation of the transmitter. The algorithm 500 can be executed whenever there is a desire to change the data rate of the communications system. The controller can begin by determining a ratio of the desired data rate to the full data rate (block 505). For example, if the desired data rate is 2.8 Mbps and the full data rate is 11 Mbps, then the ratio of desired data rate to full data rate is approximately 0.25. With the ratio determined, the controller can determine the number of OFDM symbols that it needs to transmit within a given duration to meet the desired data rate (block 510). For example, if the ratio is 0.25, then the controller could transmit one OFDM symbol in a duration where four OFDM symbols would be transmitted to obtain the maximum data rate. Once the frequency of OFDM symbols is determined, the transmitter may send information to inform the receiver of its transmission pattern and so forth.

By not transmitting at every available time period, an increase in the peak transmit power may arise. This can cause problems with certain transmitter implementations, such as a CMOS implementation of the transmitter. However, if peak transmit power at full PRF is at less than 0 dBm (the maximum transmit power), then there is room for the increased the transmit power. Alternatively, transmit power can be decreased at the expense of some of the excess link margin.

The power consumed by digital and analog circuits can be a function of their complexity and how fast they are clocked. Therefore, power consumption can be reduced if the complexity of circuits can be reduced. The complexity of circuits can be reduced by relaxing the precision requirements of computations and manipulations performed by the circuits.

With reference now to FIG. 6, there is shown a flow diagram illustrating an algorithm 600 for reducing power consumption via a reduction in the complexity of circuits, according to a preferred embodiment of the present invention. According to a preferred embodiment of the present invention, the excess link margin of the Multi-band-OFDM communications system can be used to decrease the complexity and thereby the power consumption of circuits in transmitters and receivers in the communications system. For example, the resolution of the communications system can be reduced by reducing the resolution of ADCs (such as ADC 433 and 434 (FIG. 4)) in the receiver. For a one bit reduction in the resolution of the ADC, a power consumption reduction of a factor of two (2) can be realized. Therefore, as long as the performance of the communications system remains above a specified minimum, the reduction in the resolution of the ADC can be exploited. A measure of the performance of the communications system may be the bit-error rate (BER), packet-error rate (PER), frame-error rate (FER), signal-to-noise ratio (SNR), signal-to-interference ratio (SIR), and so on. As long as the specified performance metric remains above specified limits, further power consumption reduction may be taken by reducing the resolution of the ADCs (and other circuitry in the communications system).

In addition to reducing the resolution of the ADC, the internal precision of Fourier transforms and post-Fourier transform processing algorithms can be lowered to further reduce power consumption. The reduction in the internal precision of the Fourier transform and post-Fourier transform processing algorithms can result in a decrease in a signal-to-quantization noise ratio (SQNR) of Fourier transform, frequency-domain equalizer, and phase/time tracking units. This can result in a reduction in any excess link margin that may be present. For example, if the internal precision of the Fourier transform were to be reduced from 10 bits down to seven bits, the power consumption may go down by nearly a factor of two (Fourier transform power consumption can be dominated by multiplication operations and multiplier size scales quadratically with input bit width). Similarly, power consumption of a decoder (the Viterbi decoder 467 (FIG. 4)) can be reduced by using a smaller trace-back depth, which for lower data rates, could decrease decoder power consumption (due to a decrease in memory access). Preferably, the decoder should be designed so that the trace-back depth can be configurable (programmable) so that it can be changed with the data rate.

According to a preferred embodiment of the present invention, the algorithm 600, which can be used to reduce power consumption in a receiver, can execute on a controller, a general purpose processing unit, a dedicated processing unit, or a custom designed integrated circuit that may be responsible for the operation of the receiver. The algorithm 600 may be executed whenever there is a desire to change the power consumption of the receiver. The controller can begin by specifying a desired power consumption reduction and a performance metric, such as the BER, PER, FER, SNR, SIR, and so on (block 605). Alternatively, the allowable performance metric may be specified by a technical specification to which the communications system adheres. For example, the technical specifications may not permit a specific performance metric to exceed a certain limit at a given data rate or at a certain distance.

The controller can then make a measurement of the performance metric (block 610). This performance metric measurement may be used as a comparison performance metric. The controller can compare the measured performance metric against the allowable performance metric (block 615). If the measured performance metric is worse the allowable performance metric, then the receiver may already be performing worse than expected and the precision of the circuitry (such as the ADC, Fourier transform, processing units, decoders, and so forth) should be increased, if possible, to improve the performance of the communications system (block 620). Note that even if the circuitry in the receiver are already operating at maximum precision, it may still be possible that the receiver is operating worse the allowable performance metric. This may be due to many factors, such as interference, noise, distance between transmitter and receiver, and so on.

If the performance metric is not worse (better) the allowable performance metric, then the controller can make a measurement (or estimate) of the power consumption (block 625). This measurement (or estimate) may be based upon the known precision of the circuitry in the receiver. Note that it may be possible to perform the power consumption measurement for the receiver prior to it being used (in the laboratory or during manufacture, for example) by the end-user and have the measurement stored in look-up table or a memory. The look-up table may be indexed by the precision of the circuitry in the receiver (such as the number of bits used by the circuitry in the various operations and set in block 620) or operating mode of the receiver (such as a transmission pattern it is receiving and so forth) and an estimate of the power consumption can be readily retrieved without needing to perform a measurement. If the power consumption is less than the desired amount (block 630), then the algorithm 600 can terminate since it has met both the performance and the power consumption requirements. If the power consumption is greater than the desired amount, then the controller can decrease the precision of some (or all) of the circuitry in the receiver (block 635). According to a preferred embodiment of the present invention, the controller can decrease the precision in one circuit until it reaches a predetermined minimum before it attempts to decrease the precision in another circuit. Alternatively, the controller can decrease the precision in one circuit and if it needs to further decrease the precision, it may decrease the precision in another circuit before it goes back to decrease the precision of the initial circuit. After decreasing the precision of the circuit(s), the controller can return to block 610 to measure the performance metric for the receiver. The algorithm 600 can continue until it has met the performance and power consumption requirements.

In certain circumstances, it may not be possible for the controller to meet either (or both) of the performance and power consumption requirements, therefore, a counter (or flag) may be used to keep track off the number of times that the controller attempts to adjust the precision of the receiver's circuitry. If the controller attempts to adjust the circuitry too many times and the requirements remain unmet, then the controller can terminate the execution of the algorithm 600. Note that the use of the counter (or flag) to terminate the execution of the algorithm 600 is not shown in FIG. 6, but the addition of such a counter (or flag) would require minor modifications to the algorithm 600 and should be readily evident to those of ordinary skill in the art of the present invention. Alternatively, rather than counting a number of times that the precision of the circuitry is adjusted, the controller can terminate the execution of the algorithm 600 based upon a prespecified threshold, such as a hysteresis. For example, the controller can terminate the execution of the algorithm 600 if the performance metric is within a prespecified threshold of the allowable performance metric. As yet another alternative, the controller can terminate the execution of the algorithm 600 if the performance metric has been adjusted for a specified amount of time.

With reference now to FIG. 7, there is shown a data plot illustrating a packet error rate (PER) for a Multi-band-OFDM communications system as a function of E_{b}/Nₒ for varying ADC precision, according to a preferred embodiment of the present invention. The data plot illustrates the effect on the PER for different number of bits in the precision of the ADC in the receiver of the Multi-band-OFDM communications system. A first curve 705 actually represents the PER for the case when the ADC has six (6) and five (5) bits of precision. The PER is essentially the same as a function of E_{b}/Nₒ for both cases and the curves lie on one another. A second curve 710 shows the PER for the case when the ADC has four (4) bits of precision. A third curve 715 shows the PER for the case when the ADC has three (3) bits of precision while a fourth curve 720 shows the PER for the case when the ADC has two (2) bits of precision. Clearly, the precision of the ADC can be dropped from a maximum of six down to three without a significant reduction in PER, a performance degradation of approximately 0.5 dB at a PER of 8 percent.

A source of significant power consumption for transmitter and receiver in a Multi-band-OFDM communications system can be the mixers used to provide time-frequency interleaving. While time-frequency interleaving can be necessary to permit the sharing of available bandwidth among multiple communicating devices, the presence of circuitry needed to perform frequency synthesis and up-conversion/down-conversion can consume significant amounts of power.

With reference now to FIG. 8, there is shown a flow diagram illustrating an algorithm 800 for reducing power consumption by reducing the use of time-frequency interleaving, according to a preferred embodiment of the present invention. As discussed previously, the use of time-frequency interleaving can improve the utilization of available bandwidth by permitting multiple communications devices access to the communications channel. Furthermore, time-frequency interleaving can prevent the static allocation of a transmission channel to communications devices that may only infrequently use the transmission channel, thereby allowing other communications devices access to the lightly used bandwidth.

A reduction in the use of time-frequency interleaving can be achieved in several ways. A first and potentially simplest way would be to increase the duration at each transmission band. For example, if a current Multi-band-OFDM communications system changes transmission band after each symbol, then the duration can be increased so that the Multi-band-OFDM communications system changes transmission band after a frame, multiple frames, or a superframe. Since the power consumption in time-frequency interleaving occurs mainly when a transmission is taking place, minimizing power consumption can occur if the duration was extended to the entire length of the transmission. However, this can be impractical and can incur some of the negative aspects of not using time-frequency interleaving, such as under utilization of available bandwidth and potential starvation of certain transmitters.

Instead of simply increasing the duration at each transmission band, the Multi-band-OFDM communications system can continue to use the standard transmission band duration, e.g., one symbol duration, when there are no transmissions. Note that when there are no transmissions, the transmitter and receiver need not be active. They just need to keep track of the interleaving sequence so the proper transmission band will be used when a transmission needs to occur. However, when there is a transmission, the Multi-band-OFDM communications system remains in one transmission band until the transmission completes. By holding the transmission band until the transmission completes, the Multi-band-OFDM communications system can minimize the use of the mixers and frequency synthesizers, thereby reducing power consumption. For example, in a Multi-band-OFDM communications system that switches frequencies once every 9.5 ns, a total of two (2) mixer may be needed at the receiver and two (2) mixers may be needed at the transmitter for just one of the two quadrature phases, for example, I (in-phase). Therefore, if during a transmission no time-frequency interleaving were to take place, the four (4) mixers can be inactive and reduce the power consumption in the receiver and the transmitter.

According to a preferred embodiment of the present invention, the algorithm 800, which can be used to reduce power consumption in a transmitter and a receiver, can execute on a controller, a general purpose processing unit, a dedicated processing unit, or a custom designed integrated circuit that may be responsible for the transmission and receiving in the transmitter and receiver. The controller can check to see if there is a transmission taking place (block 805). If there is a transmission taking place, then the controller should remain in the current transmission band (block 810). If there is not a transmission taking place, then the controller can change transmission band (block 815).

Note that for some frequency division multiple access systems, the amount of time that the system uses a transmission band may be indefinite. In such a case, then the system may not change from the transmission band on which it is transmitting. Alternatively, if it is known before hand the operating modes that may be used, the communications equipment in the system can be designed with multiple frequency synthesis units. For example, there may be a frequency synthesis unit for when the system does not change transmission bands and a separate frequency synthesis unit for when the system does change transmission bands. Then, depending upon the operating mode, the appropriate frequency synthesis unit can be used while the other may be turned off.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for reducing power consumption and data transfer rate in a wireless communications system, the method comprising:
determining a desired data transfer rate to full data transfer rate ratio (DFR); and
transmitting actual data symbols at an actual data symbols to full data symbols ratio (AFR) that is substantially equal to the DFR.

2. The method of claim 1, wherein the full data transfer rate is the data transfer rate achieved when all data symbols being transmitted contain actual data.

3. The method of claim 1, wherein periods of the transmission when an actual data symbol is not being transmitted contains a zero amplitude signal.

4. The method of claim 1 further comprising sending a transmit pattern message to receivers prior to the transmitting.

5. The method of claim 4, wherein the transmit pattern message contains information regarding data symbol usage.

6. The method of claim 5, wherein the transmit pattern message contains a list of which data symbols will contain actual data.

7. The method of claim 1, wherein the wireless communications system is a multi-band, orthogonal frequency division multiplexed communications system.

8. A method for adjusting the precision of circuitry in a wireless communications system, the method comprising:
measuring a performance metric of a receiver;
increasing the precision of circuitry if the performance metric exceeds a first specified threshold;
obtaining a power consumption estimate of the receiver;
decreasing the precision of the circuitry if power consumption estimate exceeds a second specified threshold; and
repeating the adjusting of the precision of the circuitry according to a performance requirement.

9. The method of claim 8 further comprising limiting the adjusting of the precision of the circuitry based upon a third threshold.

10. The method of claim 8, wherein the circuitry is selected from a group consisting of an analog-to-digital converter (ADC), Fourier transform unit, decoder, frequency domain equalizer, or combinations thereof.

11. The method of claim 8, wherein the performance metric is one or more of the following: the frame error rate (FER), the bit error rate (BER), the packet error rate (PER), the signal-to-noise ratio (SNR), the signal-to-interference ratio (SIR).

12. The method of claim 8, wherein the obtaining comprises measuring the power consumption by the receiver.

13. The method of claim 8, wherein the obtaining comprises looking up a power consumption estimate stored in a look-up table.

14. The method of claim 13, wherein the look-up table can be indexed by the precision of the circuitry.

15. The method of claim 8, wherein the receiver is part of a wireless communications system using multi-band, orthogonal frequency division multiplexing.

16. A method for reducing power consumption in a wireless communications system, the method comprising:
determining if a transmission is taking place;
changing transmission band at a next interval if a transmission is not taking place; and
maintaining the transmission band if a transmission is taking place.

17. The method of claim 16, wherein the changing comprises keeping track of the transmission band to use if there is a transmission.

18. The method of claim 16, wherein a transmission can occupy multiple intervals, and while a transmission is taking place, the current transmission band is maintained.

19. The method of claim 16, wherein a transmission can occupy a single interval, and while a transmission is taking place, the current transmission band is maintained.

20. The method of claim 16 further comprising changing transmission band at a next interval after the transmission is complete.

21. The method of claim 16, wherein the wireless communications system is a multi-band, orthogonal frequency division multiplexed communications system.

22. The method of claim 16, wherein an interval can have indefinite duration, and wherein transmission bands are not changed in mid-interval.
